(19) United States
(12) Patent Application Publication
(10) Pub. No.: US 2025/0249510 A1
(43) Pub. Date: Aug. 7, 2025

(54) CONSTRUCTION CHAMBER FOR A MACHINE AND MACHINE FOR PRODUCING A THREE-DIMENSIONAL COMPONENT

(71) Applicant: TRUMPF Laser- und Systemtechnik SE, Ditzingen (DE)

(72) Inventor: Karl MERZ, Leimbach (CH)

(21) Appl. No.: 19/186,660

(22) Filed: Apr. 23, 2025

Related U.S. Application Data
(63) Continuation of application No. PCT/EP2023/078507, filed on Oct. 13, 2023.

(30) Foreign Application Priority Data
Oct. 27, 2022 (DE) 10 2022 128 420.4

(51) Int. Cl. B22F 12/30; B22F 10/28; B22F 12/00; B28B 1/00; B33Y 30/00

(52) U.S. Cl. CPC B22F 12/30; B22F 12/222; B22F 12/38; B28B 1/001; B22F 10/28; B33Y 30/00

(57) ABSTRACT

A construction chamber is provided for a machine for producing a three-dimensional component by selectively solidifying a construction material applied in layers by means of a jet acting on the construction material. The construction chamber includes a construction cylinder in which a substrate plate is configured to be moved up and down along a construction cylinder wall, an opening provided at an upper end of the construction cylinder for introducing the construction material into the construction cylinder, and a drive unit, which controls the substrate plate within the construction cylinder so that the substrate plate can be moved up and down. A closed circumferential wall is formed, which surrounds the construction cylinder, and the drive unit is provided within the closed circumferential wall.

### CROSS REFERENCE TO RELATED APPLICATIONS

This application is a continuation of International Application No. PCT/EP2023/078507 (WO 2024/088794 A 1), filed on Oct. 13, 2023, and claims benefit to German Patent Application No. DE 10 2022 128 420.4, filed on Oct. 27, 2022. The aforementioned applications are hereby incorporated by reference herein.

### FIELD

The invention relates to a construction chamber for a machine for producing a three-dimensional component by selectively solidifying a construction material applied in layers, and also relates to such a machine.

### BACKGROUND

From EP 1 037 739 B2, a machine is known for producing a three-dimensional component by selectively solidifying a construction material applied in layers by means of a jet acting on the construction material. This construction chamber comprises a construction cylinder with a construction cylinder wall, within which a substrate plate can be moved up and down. To control the lifting movement of the substrate plate, a drive unit with a guide is provided outside the construction cylinder, along which a support arm can be moved up and down. This support arm extends through a slot in the construction cylinder into the interior of the construction cylinder in order to grip the substrate plate and move it up and down. The slot in the construction cylinder wall is closed with a removable band.

Furthermore, WO 2020/120888 A 1 discloses a construction chamber for a machine for producing a three-dimensional component. A substrate plate is guided so as to be movable up and down within the construction cylinder. A drive unit is provided outside a construction cylinder wall of the construction cylinder and arranged laterally to the outer circumference of the construction cylinder. This drive unit comprises three guide rods distributed around the circumference of the construction cylinder, on which guide carriages are guided so as to be movable up and down. The guide carriages are moved up and down by means of a threaded rod. Support arm sections are provided on the guide carriage, which protrude through slots in the construction cylinder wall into the interior of the construction cylinder in order to pick up the substrate plate and move it up and down. These slots are closed by a detachable band depending on the stroke position of the guide carriage.

### SUMMARY

In an embodiment, the present disclosure provides a construction chamber for a machine for producing a three-dimensional component by selectively solidifying a construction material applied in layers by means of a jet acting on the construction material. The construction chamber includes a construction cylinder in which a substrate plate is configured to be moved up and down along a construction cylinder wall, an opening provided at an upper end of the construction cylinder for introducing the construction material into the construction cylinder, and a drive unit, which controls the substrate plate within the construction cylinder so that the substrate plate can be moved up and down. A closed circumferential wall is formed, which surrounds the construction cylinder, and the drive unit is provided within the closed circumferential wall.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a machine for producing three-dimensional components according to an embodiment of the present invention;

FIG. 2 shows a perspective view of a first embodiment of a construction chamber for the machine according to FIG. 1;

FIG. 3 shows a perspective sectional view of a drive unit of the construction chamber according to FIG. 2;

FIG. 4 shows a schematic view of a first step for a lifting movement of the drive unit according to FIG. 3;

FIG. 5 shows a schematic sectional view of a further step for a lifting movement of the drive unit according to FIG. 3;

FIG. 6 shows a schematic sectional view of a final step for a lifting movement of the drive unit according to FIG. 3;

FIG. 7 shows a schematic sectional view of an alternative embodiment of the drive unit in relation to FIG. 3;

FIG. 8 shows a perspective view of an alternative embodiment of the construction chamber in relation to FIG. 2;

FIG. 9 shows a schematic sectional view of the construction chamber according to FIG. 8;

FIG. 10 shows a schematic view of a step of a lifting movement of the drive arrangement according to FIG. 9;

FIG. 11 shows a schematic sectional view of a further step of the lifting movement of the drive unit according to FIG. 9;

FIG. 12 shows a perspective view of a further alternative embodiment of the construction chamber in relation to FIG. 8;

FIG. 13 shows a perspective view of the drive unit according to FIG. 12;

FIG. 14 shows a schematic sectional view of a closure mechanism for a detachable band for a longitudinal slot in the construction cylinder according to an embodiment of the present invention;

FIG. 15 shows a schematic side view of the construction chamber with a cooling arrangement according to an embodiment of the present disclosure; and

FIG. 16 shows a perspective view of an alternative embodiment according to the present invention of a construction cylinder with a closure.

### DETAILED DESCRIPTION

An embodiment of the present invention relates to a construction chamber for a machine for producing a three-dimensional component by selectively solidifying a construction material applied in layers by means of a jet acting on the construction material, and another embodiment relates to such a machine.

Embodiments of the present invention provide a construction chamber for a machine and a machine for producing a three-dimensional component by selectively solidifying a construction material applied in layers by means of a jet acting on the construction material, which comprises a small installation size and at the same time enables a reduction in interfaces to the environment.

Embodiments of the present invention provide a construction chamber for a machine for producing a three-dimensional component by selectively solidifying a construction material applied in layers by means of a jet acting on the construction material, having a construction cylinder in which a substrate plate can be moved up and down along a construction cylinder wall, which construction cylinder having an opening provided at the upper end for introducing construction material into the construction cylinder, and having a drive unit, which controls the substrate plate within the construction cylinder so that it can move up and down, wherein a closed circumferential wall is formed, which surrounds the construction cylinder, and wherein the drive unit is provided within the closed circumferential wall. This design of the construction chamber enables, on the one hand, the overall construction height of such a construction chamber to be reduced and substantially determined by the height of the construction cylinder, and, on the other hand, due to the closed circumferential wall which surrounds the construction cylinder on the outside, enables a reduction in interfaces to the construction space in the construction cylinder, through which the inner volume of the construction cylinder can come into contact with the environment for the exchange of oxygen, so that oxidation of the construction material is reduced.

Advantageously, embodiments can provide that the circumferential wall surrounding the construction cylinder on the outside is connected, and in a preferred embodiment firmly connected, to the construction cylinder. The height of the circumferential wall in a preferred embodiment extends at least partially, in a particular embodiment completely, along the height of the construction cylinder. This allows a hermetic sealing of the construction cylinder, at least with regard to its outer circumference, by the circumferential wall.

The drive unit for moving the substrate plate up and down is, in a preferred embodiment, provided flush in a lowest position or within a lower end of the construction cylinder. As a result, the overall height of the construction chamber may be limited by the required height of the construction cylinder.

According to a first embodiment of the construction chamber, it is provided that the drive unit is arranged within the construction cylinder wall of the construction cylinder. Alternatively, it can be provided that the drive unit extends at least partially, in a preferred embodiment completely, between the circumferential wall and the construction cylinder wall. Both embodiments have the advantage that the closed circumferential wall surrounding the construction cylinder can be maintained.

According to a first embodiment, the drive unit has two separately controllable lifting elements, each comprising a clamping element, which can be controlled independently of one another and successively for clamping and releasing. This makes it possible to control a step-by-step lifting movement of the drive unit for lowering the substrate plate during the manufacturing process of the three-dimensional component. A nalog lifting of the substrate plate for removal from the construction cylinder can also be controlled.

In a preferred embodiment, the clamping element is provided between the lifting element and the construction cylinder wall of the construction cylinder and the respective lifting element is held clamped to the construction cylinder wall by the pressurization of the clamping element. This is a space-saving arrangement. In addition, it is possible for the construction cylinder wall to be completely closed.

To control a lifting movement of this first embodiment of the drive unit, in a preferred embodiment, it is provided that the first lifting element is held clamped in the construction cylinder by the clamping element and the second lifting element can be controlled with a lifting movement and at the end of the lifting movement of the second lifting element, its clamping element can be pressurized for clamping in the construction cylinder and subsequently the clamping element of the first lifting element is released and the first lifting element can be controlled with a lifting movement. Through this step-by-step, successive control, the drive unit can perform a secure lifting movement both upwards and downwards within the construction cylinder.

To control the lifting movement, in an embodiment, the drive unit advantageously comprises a gear which is provided between the first and second lifting element. This in turn enables a compact arrangement.

The gear for controlling the relative movement between the first and second lifting element or the lifting movement comprises a threaded pair, wherein a ring with an internal thread is provided on the first lifting element, and the second lifting element is coupled to a toothed ring which has an external thread and, in a preferred embodiment, the toothed ring comprises an inner toothing, by means of which the toothed ring can be driven by a motor. This gear, which can also be a fine thread, can be used to precisely control a stroke, which can, for example, be in the micrometer range.

Advantageously, an embodiment provides that the first and second lifting elements have an annular contour, wherein the first lifting element forms a C-shaped cross-section with an upper and lower lifting segment and the second lifting element is provided in between, which is guided so as to be movable up and down between the upper and lower lifting segment of the first lifting element. This represents a compact, nested arrangement, which also allows the installation height of the drive unit to be kept low.

The first and second lifting elements of the drive unit can advantageously have an outer circumferential surface which at least partially corresponds to the contour of an inner circumferential surface of the construction cylinder wall of the construction cylinder. The clamping element can be designed as a clamping band surrounding the outer circumferential surface of the lifting elements. This allows large-area clamping with a high holding force to be achieved.

The outer edges of the clamping band are firmly connected to the respective lifting element, thereby forming an inner annular surface which can be pressurized by a medium. The inner annular surface can be pressed outwards in a bulging manner, which enables clamping to the inner circumferential surface of the construction cylinder wall.

Furthermore, in a preferred embodiment, it is provided that the motor of the drive unit can be positioned within the first and second lifting elements. The annular arrangement allows a free space to be created inside the first and second lifting elements. This in turn enables a compact design. In addition, the control of the lifting elements can be simplified because the motor moves along with the up-and-down movement of the drive unit.

Advantageously, a substrate plate holder can be provided above the drive unit, which enables an interface for exchangeably receiving the substrate plate. This interface has the advantage that, for example, preheated substrate plates can be provided for a subsequent construction process and can be positioned on the drive unit so that a new construction process for producing a three-dimensional component can be started immediately afterwards.

Furthermore, in a preferred embodiment, it is provided that the size of the stroke of the drive unit can be controlled by the number of revolutions of the motor which controls the gear, which acts between the lifting elements, and the drive movement of the motor can be converted into a lifting movement by the gear. This also makes it possible to control lifting movements of the lifting elements that are smaller than the maximum lifting height between the first and second lifting elements.

According to a further alternative embodiment of the drive unit, it is provided that the drive unit comprises at least three lifting rods and a support arm is provided on each lifting rod, which is guided so as to be movable up and down along the lifting rod. These lifting rods for the up-and-down movement of the support arms are preferably provided between the construction cylinder wall of the construction cylinder and the closed circumferential wall.

The construction cylinder wall of the construction cylinder, in a preferred embodiment, comprises a longitudinal slot assigned to each lifting rod, so that the up-and-down movable support arms extend through the longitudinal slot into the interior of the construction cylinder. Due to the outer circumferential wall surrounding the construction cylinder, the interior of the construction cylinder can still be closed off from the environment in relation to the outer circumferential wall. This also prevents a connection with the environment and thus an exchange of oxygen.

In a particular embodiment, it is provided that the longitudinal slot in the construction cylinder wall of the construction cylinder can be closed by a closure mechanism with a detachable band, which follows the lifting movement of the support arm. This can also reduce or prevent contamination of a gap between the construction cylinder wall and the circumferential wall with construction material.

In this embodiment, a base is preferably provided on the construction cylinder, which extends to the circumferential wall. As a result, the construction chamber is only open with respect to the upper opening facing the working plane for supplying the construction material and is otherwise closed.

In this alternative drive unit embodiment, it is preferably provided that the lifting rod is designed as a cylindrical guide pin and at least two clamping sleeves are provided between the lifting rod and the support arm, wherein the first clamping sleeve can be clamped against the lifting rod and the second clamping sleeve against the circumferential wall or a guide inserted between the circumferential wall and the construction cylinder wall. These clamping sleeves can be controlled independently and successively for tightening and loosening. This allows a lifting movement analogous to the first embodiment to be achieved.

In this alternative embodiment, it is preferably provided that a piston chamber is provided in the base in an area between the construction cylinder and the circumferential wall for each lifting rod, in which a piston fixedly arranged on the lifting rod is guided so as to be movable up and down and the piston receptacle is closed with a closure. The height of the piston chamber limits the maximum lifting movement for a support arm. However, such a piston chamber enables easy control of the lifting movement, for example by means of a pressure medium, in particular compressed air. Alternatively, hydraulic pressurization may also be possible.

One end of the lifting rod, in a preferred embodiment, extends below the base of the construction cylinder, on which an adjusting device is provided for controlling the lifting movement. This arrangement has the advantage that the additional lifting rods arranged around the circumference can be simultaneously adjusted in terms of their stroke and are easily accessible from the outside.

The adjusting device for controlling the stroke advantageously comprises a lift adjusting nut which engages an adjusting section of the lifting rod and can be adjusted in height by means of a thread, wherein the lift adjusting nut has an external toothing. This external toothing can be provided for a common control of the adjusting device for the stroke.

In a preferred embodiment, all adjusting devices for adjusting the stroke of the lifting rod are controlled synchronously together with a belt or gear. This ensures that the same conditions are present for the controlled lifting movement for all drive units.

Furthermore, in this alternative embodiment, it can be provided that a bearing is provided at the upper end of the lifting rod between the construction cylinder wall and the circumferential wall, through which the lifting rods are guided so as to be movable up and down within the guide and in a rotationally secure manner. This means that, on the one hand, a lifting movement of the lifting rods can be controlled and, on the other hand, the synchronous adjustment of the stroke can be controlled by the adjusting device which is provided at the lower end of the lifting rod.

In the alternative embodiment of the drive unit, the lifting movement can be provided as follows: For a lifting movement of the support arm along the lifting rod designed as a guide pin, the piston of the lifting rod is arranged in a lower position in the piston chamber. The clamping sleeve, which acts on the circumferential wall of the guide, is then loosened. The clamping sleeve acting on the lifting rod is clamped. Subsequently, pressure is applied to the piston chamber and the lifting rod with the support arm is moved vertically upwards in accordance with the set stroke. The clamping sleeve is then clamped against the circumferential wall or guide and the clamping between the clamping sleeve and the lifting rod is released. The lifting rod can thus be moved into the lower position, in particular after the piston chamber has been depressurized. The clamping sleeve to the lifting rod is then clamped again and the clamping sleeve to the circumferential wall or to the guide is depressurized so that a new lifting cycle can subsequently be controlled. A downwards movement of the substrate plate in the construction cylinder can be carried out analogously.

According to a further alternative embodiment of the drive unit, it is provided that the lifting rod is formed by a threaded spindle instead of a guide pin and a spindle nut is provided between the threaded spindle and the support arm. In this embodiment, an up-or-down movement of the support arm can be controlled by a rotatable drive of the threaded spindle. In this embodiment, it can be provided that the pitch of the threaded spindle is selected such that it includes a self-locking mechanism, so that in the event of an operational malfunction, such as a power failure, there is a fall protection mechanism.

In this further alternative embodiment, it is preferably provided that a pinion is provided at the lower end of the threaded spindle, preferably in the base of the construction chamber, and each threaded spindle is coupled by a common toothed ring which can be controlled by a motor or that each threaded spindle can be controlled separately by a motor.

According to a further advantageous embodiment of the construction chamber, it can be provided that a cooling arrangement is provided between the circumferential wall and the construction cylinder wall of the construction cylinder. This can reduce the heating of the environment outside the construction chamber.

According to a further preferred embodiment of the construction chamber, a preferably detachable closure is provided on an underside of the closed circumferential wall, which is connected to the closed circumferential wall in a media-tight, in particular gas-tight, manner. This closure, which can also be trough-shaped or lid-shaped, closes the underside of the circumferential wall surrounding the construction cylinder. This can provide oxygen protection, allowing the construction chamber to be hermetically sealed.

Embodiments of the present invention provide a machine for producing three-dimensional components by selectively solidifying a construction material applied in layers by means of a jet acting on the construction material, which comprises at least one process chamber which has at least one working surface aligned in an X/Y plane, to which a construction chamber is assigned, in which a substrate plate is movably controlled by a drive unit and on which the three-dimensional component is produced, as well as with a jet source for generating the jet and at least one deflection device by which the at least one jet is guided and deflected onto the construction material to be solidified in the construction cylinder, as well as with an application and leveling device which can be moved above the working surface for applying the construction material relative to the construction chamber, wherein the construction chamber is designed according to one of the embodiments described above. Such a machine has the advantage that the overall height is reduced due to the compact design of the construction chamber. In addition, an improvement in the construction quality can be achieved because the closed circumferential wall surrounding the construction cylinder provides additional sealing of the construction cylinder against the environment to reduce or prevent oxygen from entering the construction chamber.

Embodiments of the present invention and further advantageous embodiments and developments thereof are described and explained in more detail below by means of the examples illustrated in the drawings. The features that can be derived from the description and the drawings can be used individually or in any combination together according to the present invention.

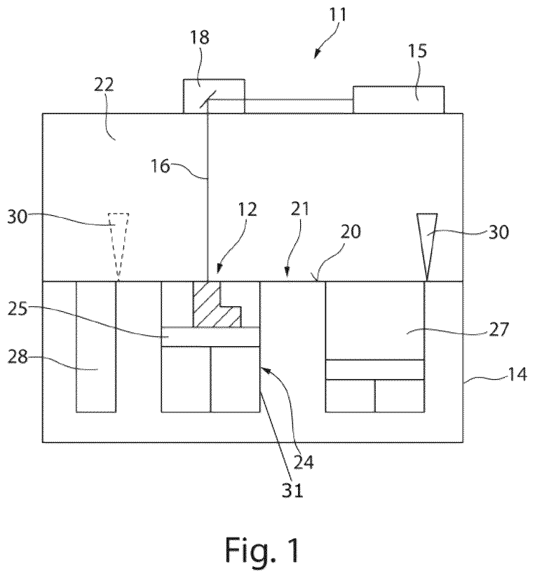

FIG. 1 shows a schematic view of a machine 11 for producing a three-dimensional component 12 by successively solidifying layers of a powdered construction material. This machine 11 comprises a machine frame 14 and a jet source 15 arranged on the machine frame 14, for example in the form of a laser source. This jet source 15 emits a jet 16 which is deflected and guided via a jet deflection device 18 onto a working plane 20 of a working surface 21 in a process chamber 22. The jet deflection device 18 can be designed in the form of one or more controllable mirrors, in particular in the form of a scanner. Below the working plane 20, a construction chamber 24 with a substrate plate 25 is provided, which can be moved within the construction cylinder 31 in order to create the three-dimensional component 12 based thereon. Adjacent to the construction chamber 24, a storage chamber 27 is provided through which powdered construction material is provided. Opposite the construction chamber 24, a collecting chamber 28 is provided. By means of an application and leveling device 30, powdered construction material is fed to the construction cylinder 31, starting from a right-hand starting position shown in FIG. 1. Unused construction material is transferred to the collection chamber 28 (left end position) by means of the application and leveling device 30 so that it can be processed and reused. The application and leveling device 30 may comprise one or more brushes, strips, rubber lips or the like. These can be adjusted in height to rest on the working level 20 so that a quantity of powdered construction material provided from the storage chamber 27 can be transferred into the construction chamber 24 for the subsequent solidification process.

The construction material is preferably composed of a metal or a ceramic powder. Other materials suitable and used for laser melting and laser sintering may also be used. The process chamber 22 is preferably hermetically sealed off. For the production of the three-dimensional component 12, said process chamber is filled with shielding gas or an inert gas in order to prevent oxidation during the melting of the construction material.

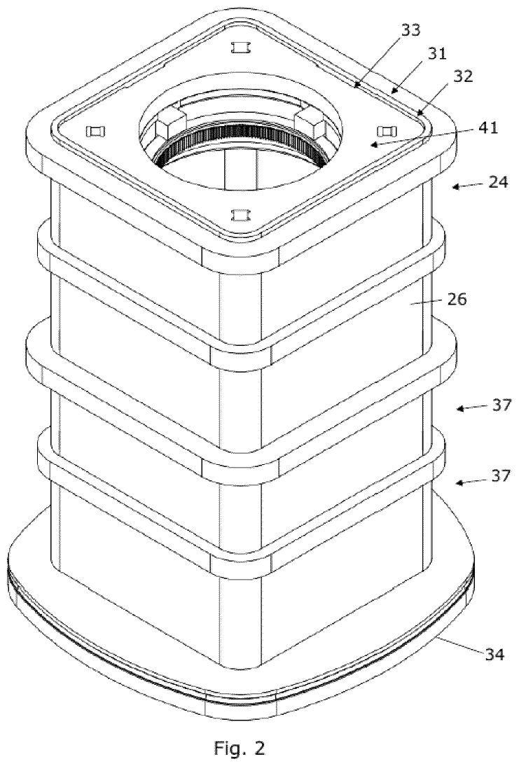

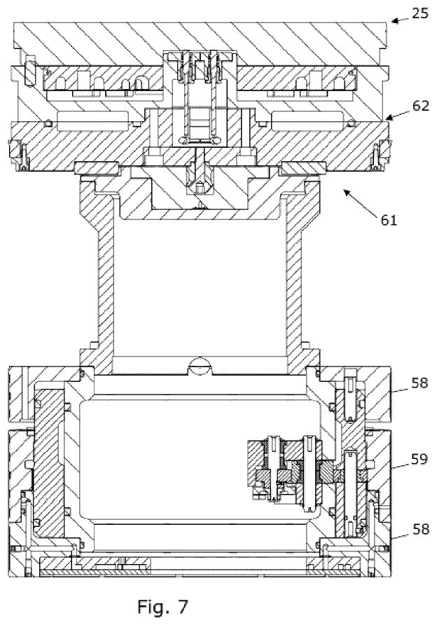

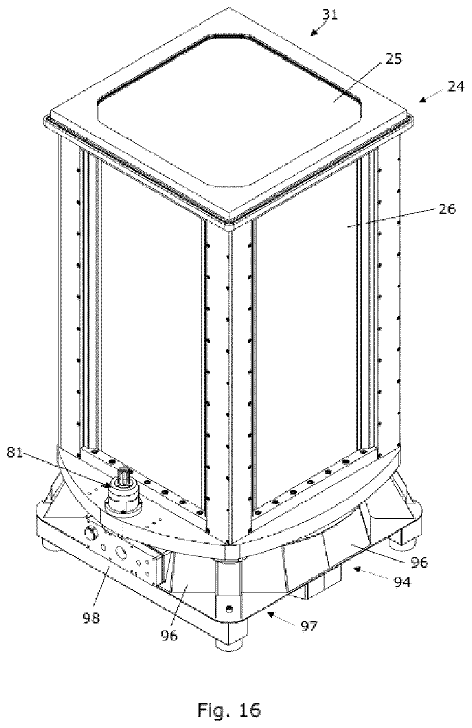

FIG. 2 is a perspective illustration of the construction chamber 24. The construction chamber 24 comprises a construction cylinder 31 with a construction cylinder wall 32. The construction cylinder 31 has an opening 33 at the upper end, which is aligned with the working surface 21. The construction cylinder 31 is surrounded by a circumferential wall 25. This circumferential wall 25 is completely closed. A base 34 is provided at the lower end of the construction chamber 24. This base 34 is advantageously completely closed except for an opening 36 (FIG. 7). The construction chamber 24 can consist of a plurality of segments 37 which are arranged one above the other and can be connected to one another. This allows a flexible design of different heights for the construction chamber 24. According to the exemplary embodiment, the construction cylinder wall 32 also forms the circumferential wall 25 of the construction chamber 24. Alternatively, a gap can be provided in between. Furthermore, it can alternatively be provided that a construction chamber 24 is formed with a continuous circumferential wall 26, as shown in FIG. 16.

A drive unit 41 is provided in the construction cylinder 31. By means of this drive unit 41, the substrate plate 25 can be moved up and down within the construction cylinder 31. For the sake of clarity, the connection to the substrate plate 25 and the substrate plate 25 are shown in FIG. 7. The drive unit 41 is arranged completely within the construction chamber 24 or the circumferential wall 26 of the construction chamber 24, in particular within the construction cylinder 31.

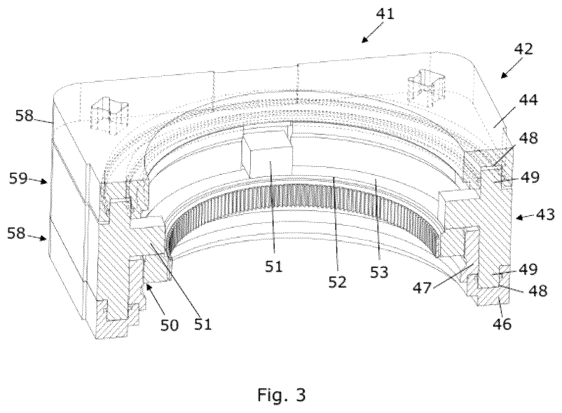

FIG. 3 shows a perspective sectional view of the drive unit 41 according to FIG. 2. The drive unit 41 comprises a first lifting element 42 and a second lifting element 43. The first and second lifting elements 42, 43 are annular, wherein the outer contour of the lifting elements 42, 43 is adapted to the format of the construction cylinder 31. In the embodiment according to FIGS. 2 and 3, the construction cylinder 31 is square with rounded corners. This construction cylinder 31 can also be circular, so that the outer contour of the lifting elements 42, 43 is adapted accordingly (FIG. 7). The first lifting element 42 is, for example, constructed in three parts and comprises an upper and lower lifting segment 44, 46, which are preferably firmly connected to a ring 47. A circumferential groove-shaped recess 48 is provided in each of the upper and lower lifting segments 44, 46. The second lifting element 43 can be moved up and down between the upper and lower lifting segments 44, 46, wherein the second lifting element has projections 49 which engage in the recesses 48. In the second lifting element 43, a plurality of radially inwardly projecting stops 15 are provided. A toothed ring 52 forms a gear 50 with an internal thread on the ring 47, by means of which a lifting movement of the first lifting element 42 or the second lifting element 43 can be controlled. The toothed ring 52 rests with an upper annular surface 53 on the undersides of the stops 51. The toothed ring 52 comprises an inner toothing to which a motor 55 or a gear 56 with a motor 55 can be directly connected (see FIG. 7).

A clamping element 58 is provided all around the outer circumference of the first lifting element 42 or on each lifting segment 44, 46. This clamping element 58 is preferably designed as a metal band. The edges thereof are firmly connected to the outer surface of the lifting segment 44, 46. A compressed air channel enables the clamping element 58 to be pressurized with compressed air so that it assumes a bulbous contour and is clamped against the construction cylinder wall 32 of the construction cylinder 31. The second lifting element 43 has a clamping element 59. This clamping element 59 corresponds in construction to the clamping element 58.

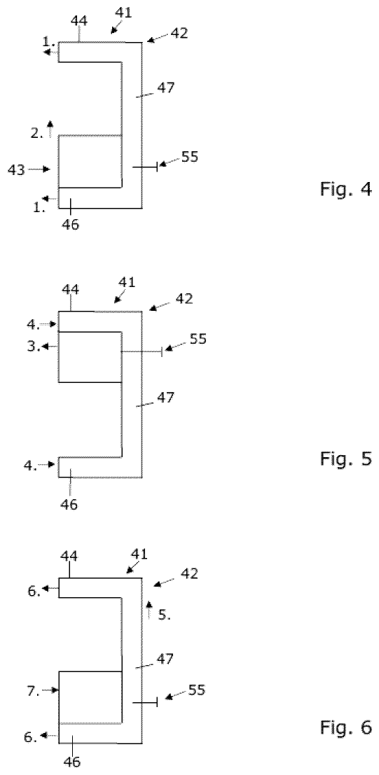

A lifting movement of this drive unit 41 is shown schematically in FIGS. 4 to 6, to which reference is made below. The first lifting element 42 is shown in a simplified C-shaped contour, wherein the upper and lower legs correspond to the lifting segment 44, 46 and the section in between corresponds to the ring 47. The second lifting element 42 is shown in between. The first lifting element 42 is fixed to the construction cylinder 31 by applying pressure to the clamping element 58 as shown in FIG. 4. Subsequently, the toothed ring 52 is driven by the motor 55, whereby the second lifting element 43 moves upwards due to the thread and the second lifting element 43 moves vertically upwards via the stops 51. The stroke can be controlled via the number of revolutions of the motor 55. The maximum stroke is limited by the distance between the lifting segments 44, 46 and the second lifting element 43, in particular the distance between the projections 49 and the recesses 48.

Subsequently, according to FIG. 5, the clamping element 59 of the second lifting element 43 is pressurized and the first clamping element 58 is released. At this point, the drive unit 41 is still at the same height as in FIG. 4.

Subsequently, according to FIG. 6, the first lifting element 41 is controlled for a lifting movement. At the end of the lifting movement, the first clamping element 58 is pressurized and the drive unit 41 is fixed in the construction cylinder 31 via the clamping element 58. The further clamping element 59 of the second lifting element 43 is released. The controlled stroke of the drive unit 41 is thus terminated. The steps described above can then be repeated.

FIG. 7 shows an alternative embodiment of the drive unit 41 according to FIG. 2. In this embodiment, it is provided that the drive unit 41, in particular the lifting elements 42, 43, comprises a circular cylindrical outer circumferential surface. The structure and mode of operation of this drive unit 41 correspond to those shown in FIGS. 2 to 6.

A substrate plate holder 61 is attached to the first lifting element 42 of the drive unit 41. This substrate plate holder 61 has a quick-release interface 62 for exchangeably receiving the substrate plate 25. Due to its annular design, the drive unit 41 enables the supply line for the motor 55 as well as for heating the heating elements in the substrate plate holder 61 to be provided inside.

The lifting movement of the drive unit 41 according to FIG. 7 corresponds to the lifting movement described in FIGS. 4 to 6.

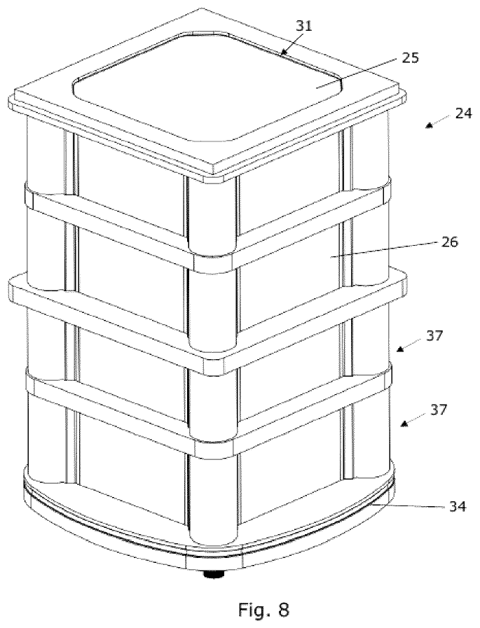

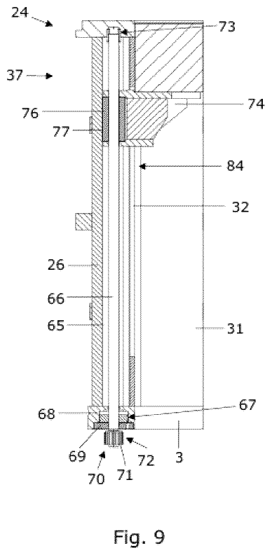

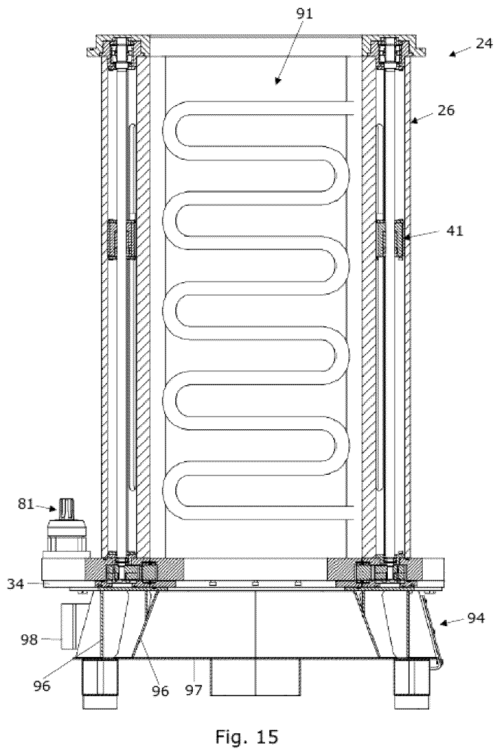

FIG. 8 shows a perspective embodiment of an alternative construction chamber 24 to FIG. 2. This construction chamber 24 corresponds to the embodiment according to FIG. 2 with regard to the structure of the segments 37. However, an alternative drive unit 41 is provided. This alternative drive unit 41 is shown in a schematic sectional view according to FIG. 9. The construction chamber 24 has a rectangular, in particular square, cross-section. The drive unit 41 is positioned in the respective corner area of the construction chamber 24 as shown in FIG. 9. Between the construction cylinder wall 32 of the construction cylinder 31 and the circumferential wall 26 of the construction chamber 24, a guide 65, in particular a slotted guide tube, is provided in the corner area. In the wall sections between the corner regions, a cooling arrangement 91 can be provided between the construction cylinder wall 32 and the circumferential wall 36 of the construction chamber 24, as shown below in FIG. 15.

The drive unit 41 comprises a lifting rod 66, which in this embodiment is designed as a guide pin. At the lower end of the lifting rod 66, a piston 67 is firmly connected to the lifting rod 66. This piston 67 is provided in a piston chamber 68 in the base 34 of the construction chamber 24. The piston chamber 68 is closed by a closure 69. The lifting rod 66 is guided out downwards through the closure 69 and has an adjusting section 71. This adjusting section 71 is designed as an external thread. This adjusting section 71 receives an externally toothed lift adjusting nut 72. A toothed ring or a toothed belt engages the lift adjusting nut 72, by means of which all lift adjusting nuts 72 of the drive unit 41 can be adjusted simultaneously. This lift adjusting nut 72 adjusts its distance from the closure 69 and thus the size of the stroke. The maximum stroke is limited by a possible travel movement of the piston 67 in the piston chamber 68.

A bearing 73 is provided at the opposite end of the lifting rod 66 or at the upper end of the lifting rod 66. By means of this bearing 73, the lifting rod 66 is mounted in a rotationally secure manner relative to the guide 65 and is axially displaceable within the guide 65.

The lifting rod 66 receives a support arm 74 which can be moved along the lifting rod 66. This support arm 74 extends through a longitudinal slot 84 in the construction cylinder wall 32 of the construction cylinder 31 into the interior of the construction cylinder 31. The substrate plate 25 rests on the support arms 74 of the drive unit 41. A first and second clamping sleeve 76, 77 is provided between the support arm 74 and the lifting rod 66. These clamping sleeves 76, 77 can be pressurized with a medium and thus generate a clamping force. Preferably, these are pressurized with compressed air. For example, the first clamping sleeve 76 creates a clamping with the guide 75, i.e., an outward clamping. The second clamping sleeve 77 can create a clamping to the lifting rod 66, i.e., an inward clamping. Both the first and second clamping sleeves 76, 77 can be positioned above or below the other.

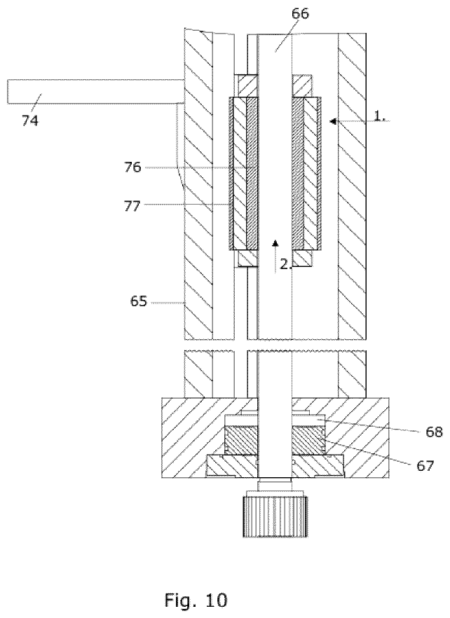

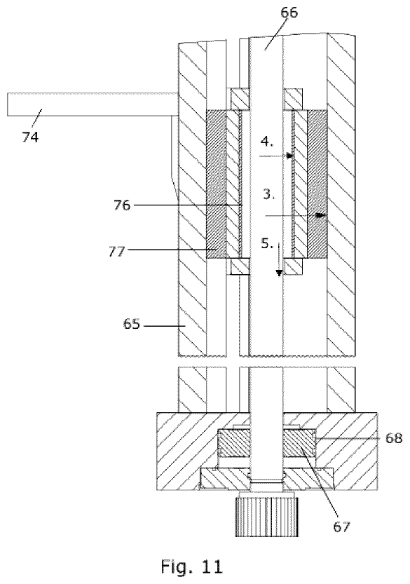

In FIGS. 10 and 11, the drive unit 41 according to FIG. 9 is shown schematically to explain a lifting movement.

The lifting rod 66 is in a lower position in FIG. 10, i.e., the piston 67 rests on the closure 69. Subsequently, a clamping takes place via the clamping sleeve 76 so that the support arm 74 is fixed to the lifting rod 66. Subsequently, the lifting rod 66 is subjected to a stroke, as shown in FIG. 10.

At the end of the stroke of the lifting rod 66, the second clamping sleeve 77 is pressurized as shown in FIG. 11, so that the support arm 74 is held fixed by the second clamping sleeve 77 via the guide 65. Subsequently, the clamping of the first clamping sleeve 76 is released so that the lifting rod can return to a lower position or starting position according to FIG. 10. The lifting movement of the support arm 74 and thus of the substrate plate 25 has thus taken place. The same applies to a downwards movement.

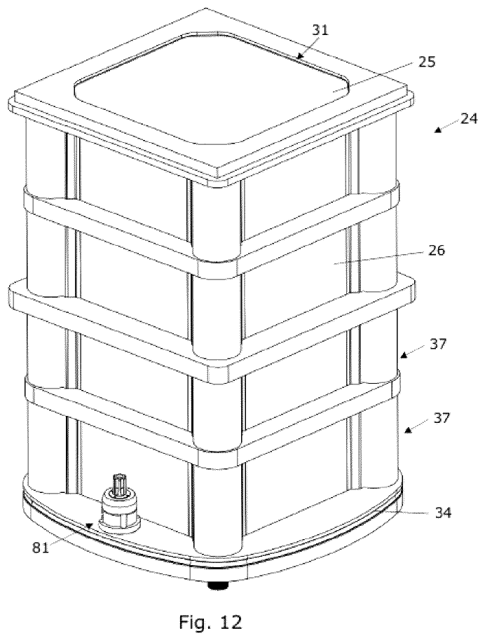

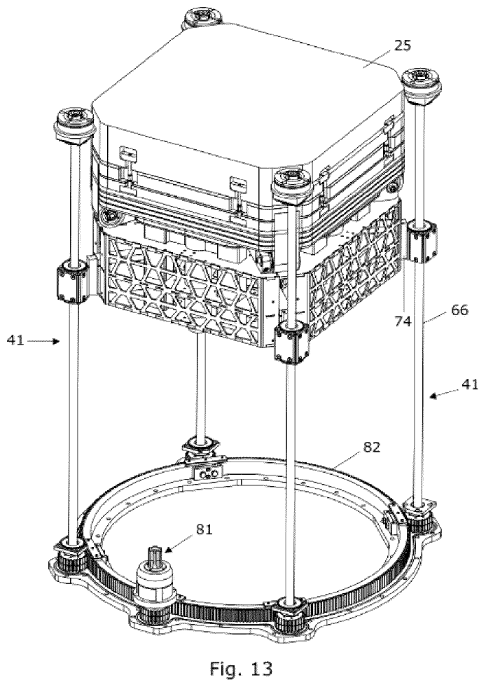

FIG. 12 shows a perspective view of an alternative embodiment of the construction chamber 24. The shape of the construction chamber 24 as well as its structure with respect to several segments 37 is retained. On the base 34 of the construction chamber 24, a gear with a connection 81 for a motor is shown. This gear connection 81 drives a toothed ring 82 or a sun gear, as shown in FIG. 13.

FIG. 13 shows the drive unit 41 of the construction chamber 24 according to FIG. 12. In the respective corner area, lifting rods 66 are provided, wherein these lifting rods 66 are designed as threaded spindles. Instead of the clamping sleeves 76, 77 according to the embodiment in FIG. 9, threaded sleeves are provided here which are connected to the support arm 74.

By initiating a rotary movement via the toothed ring 82, all threaded spindles are driven synchronously in order to adjust the height of the support arms 74 or to move the substrate plate 25 up and down.

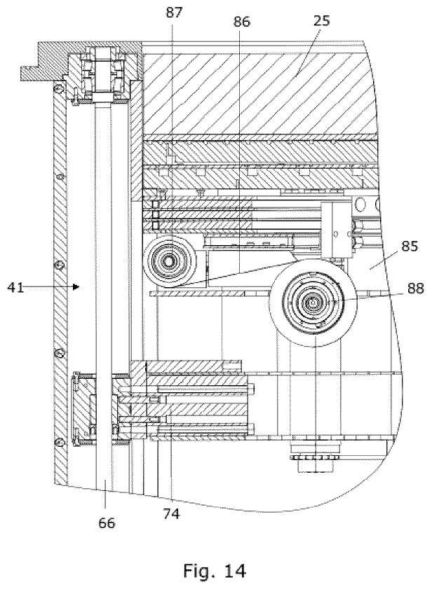

In the embodiments according to FIGS. 8 to 13, the construction cylinder wall 32 of the construction cylinder 31 comprises the longitudinal slot 84 in order to position the support arm 74 inside the construction cylinder 31. A closure mechanism 85 is shown in FIG. 14. This closure mechanism 85 comprises a detachable band 86 which comprises deflection rollers 87, 88 between the substrate plate 25 and the underlying support arm 74, by means of which the detachable band 86 opens or closes the longitudinal slot 84 in the construction cylinder 31 in accordance with the lifting movement of the support arm 74.

FIG. 15 shows a schematic side view of the embodiment of the construction cylinder 31 according to FIG. 12. FIG. 16 shows a perspective view of the construction cylinder 24 according to FIG. 15. Between the corner regions in which the respective drive unit 41 is provided, a cooling arrangement 91 can be provided between the construction cylinder wall 32 of the construction cylinder 31 and the circumferential wall 26 of the construction cylinder 24. A closure 94 is provided on an underside of the circumferential wall 26 of the construction cylinder 24. The closure 94 is detachably secured in the circumferential wall 26. Preferably, a flange connection is provided. A seal is preferably provided between the closure 94 and a lower section of the circumferential wall 26 or an underside of the circumferential wall 26. By means of this closure 94, in particular with the seal arranged therebetween, the circumferential wall 26 can also be hermetically sealed at the bottom. This provides oxygen protection so that no oxygen can enter the construction cylinder 31 via the underside of the construction chamber 24. This counteracts oxidation of the construction material in the process chamber.

The closure 94 can be trough-shaped or lid-shaped. At least one closable maintenance opening 98 can be provided in a side wall 96 and/or a base 97 of the closure 94. Such a maintenance opening 98 can be used to remove contaminants from the base 97. Such a maintenance opening 98 can also be used to feed various supply and/or media lines to the construction cylinder 31. Such maintenance openings 98 are also sealed against the environment in a media-tight manner. Furthermore, it can be additionally provided that a supply opening is provided in the closure 94 in order to supply an inert gas. This supply opening can be connected to a supply line into the process chamber 22 for supplying inert gas.

All of the above-described embodiments have in common that the construction chamber 24 has an outer closed circumferential wall 26 and the drive unit 41 for moving the substrate plate 25 up and down extends or can be moved up and down within this circumferential wall 26 of the construction chamber 24.

While subject matter of the present disclosure has been illustrated and described in detail in the drawings and foregoing description, such illustration and description are to be considered illustrative or exemplary and not restrictive. A ny statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A construction chamber for a machine for producing a three-dimensional component by selectively solidifying a construction material applied in layers by means of a jet acting on the construction material, comprising:
a construction cylinder in which a substrate plate is configured to be moved up and down along a construction cylinder wall,
an opening provided at an upper end of the construction cylinder for introducing the construction material into the construction cylinder, and
a drive unit, which controls the substrate plate within the construction cylinder so that the substrate plate can be moved up and down,
wherein a closed circumferential wall is formed, which surrounds the construction cylinder, and the drive unit is provided within the closed circumferential wall.

2. The construction chamber according to claim 1, wherein the circumferential wall surrounding the construction cylinder on an outside is connected to the construction cylinder and extends at least partially along a height of the construction cylinder.

3. The construction chamber according to claim 1, wherein the drive unit is provided in a lowest working position flush with or within a lower end of the construction cylinder.

4. The construction chamber according to claim 1, wherein the drive unit is arranged within the construction cylinder wall of the construction cylinder or wherein the drive unit is arranged at least partially between the circumferential wall and the construction cylinder wall.

5. The construction chamber according to claim 1, wherein the drive unit has two separately controllable lifting elements, each comprising a clamping element, which can be controlled independently of one another and successively for clamping and releasing.

6. A drive unit according to claim 5, wherein each clamping element is provided between the lifting element and the construction cylinder wall of the construction cylinder and the lifting element is held clamped to the construction cylinder wall of the construction cylinder by a pressurization of the clamping element.

7. The construction chamber according to claim 5, wherein a first lifting element of the two lifting elements is held clamped in the construction cylinder by a first clamping element, wherein a second lifting element of the two lifting elements can be controlled with a lifting movement and at an end of the lifting movement of the second lifting element a second clamping element can be pressurized for clamping, and wherein the first clamping element of the first lifting element is released and the first lifting element can be controlled with the lifting movement.

8. The construction chamber according to claim 5, wherein a gear is provided between a first lifting element of the two lifting elements and a second lifting elements of the two lifting elements.

9. The construction chamber according to claim 8, wherein the gear is a threaded pair, wherein a ring with an internal thread is provided on the first lifting element and the second lifting element is coupled to a toothed ring which comprises an external thread, and wherein the toothed ring comprises an inner toothing, by means of which the toothed ring can be driven by a motor.

10. The construction chamber according to claim 5, wherein a first lifting element of the two lifting elements and a second lifting element of the two lifting elements comprise an annular contour of an inner circumferential surface, wherein the first lifting element comprises a C-shaped cross-section with an upper and lower lifting segment and the second lifting element is provided in between and is guided so as to be movable up and down between the upper and lower lifting segment.

11. The construction chamber according to claim 5, wherein a first lifting element of the two lifting elements and a second lifting element of the two lifting elements each comprise at least one outer circumferential surface which at least partially corresponds to a contour of an inner circumferential surface of the construction cylinder wall of the construction cylinder, and wherein each clamping element is designed as a clamping band surrounding the outer circumferential surface of the lifting elements.

12. The construction chamber according to claim 11, wherein outer circumferential edges of the clamping bands are firmly connected to the respective lifting element and an inner annular surface of the clamping bands are configured to be pressurized by a medium.

13. The construction chamber according to claim 5, wherein a motor is configured to be positioned within the first and second lifting elements.

14. The construction chamber according to claim 1, wherein a substrate plate holder is provided above the drive unit, which comprises an interface for exchangeably receiving the substrate plate.

15. The construction chamber according to claim 9, wherein a size of a stroke of the drive unit is configured to be controlled by a number of revolutions of the motor which controls the gear and a drive movement of the motor is configured to be converted into a lifting movement by the gear.

16. The construction chamber according to claim 1, wherein the drive unit comprises at least three lifting rods and a support arm is provided on each lifting rod, which is configured to be moved up and down along the lifting rod.

17. The construction chamber according to claim 16, wherein a longitudinal slot is provided in the construction cylinder wall of the construction cylinder, through which the respective support arm extends into an interior of the construction cylinder.

18. The construction chamber according to claim 17, wherein a closure mechanism closing the longitudinal slot is provided with a detachable band which follows the support arm in accordance with the lifting movement.

19. The construction chamber according to claim 16, wherein a base is provided on the construction cylinder which extends to the circumferential wall.

20. The construction chamber according to claim 16, wherein each lifting rod is designed as a cylindrical guide pin and at least two clamping sleeves are provided between the lifting rod and the support arm, wherein the first clamping sleeve is configured to be clamped against the lifting rod and the second clamping sleeve is configured to be clamped against the circumferential wall or a slotted guide inserted between the circumferential wall and the construction cylinder wall of the construction cylinder.

21. The construction chamber according to claim 19, wherein a piston chamber is provided in the base between the construction cylinder and the circumferential wall for each lifting rod, in which a piston fixedly arranged on the respective lifting rod is guided so as to be movable up and down and in that the piston chamber is closed by a closure.

22. The construction chamber according to claim 19, wherein one end of each lifting rod extends below the base and comprises an adjusting device for controlling a stroke.

23. The construction chamber according to claim 22, wherein the adjusting device is formed by a lift adjusting nut which engages an adjusting section of the respective lifting rod, wherein the lift adjusting nut comprises an external toothing.

24. The construction chamber according to claim 22, wherein all adjusting devices of the lifting rods can be controlled simultaneously with a belt or a gear wheel synchronously for adjusting the size of the stroke.

25. The construction chamber according to claim 19, wherein a bearing is provided at an upper end of the lifting rods, by means of which the lifting rods are guided so as to be movable up and down within the guide and in a rotationally secure manner.

26. The construction chamber according to claim 16, wherein for a lifting movement of the respective support arm on the respective lifting rod designed as a guide pin, a piston of the respective lifting rod is provided in a lower position in a piston chamber and a clamping sleeve acting on the circumferential wall of a guide is released and the clamping sleeve acting on the respective lifting rod is clamped, in that the piston chamber is subsequently subjected to pressure and the respective lifting rod with the respective support arm is moved vertically upwards in accordance with a set stroke, in that the clamping sleeve is subsequently clamped against the circumferential wall or guide and then the clamping sleeve is released relative to the respective lifting rod, and in that the respective lifting rod is configured to be transferred to the lower position and then the clamping sleeve relative to the respective lifting rod is clamped again and the clamping sleeve to the circumferential wall or to the guide is depressurized.

27. The construction chamber according to claim 16, wherein the lifting rod of the drive unit is designed as a threaded spindle and a spindle nut is provided between the threaded spindle and the support arm.

28. The construction chamber according to claim 27, wherein a pinion is provided on each threaded spindle at a lower end of the threaded spindle in the base and each threaded spindle is coupled by a toothed ring which can be driven by a motor or the motor is provided on each threaded spindle.

29. The construction chamber according to claim 1, wherein a cooling arrangement is provided between the circumferential wall and the construction cylinder wall of the construction cylinder.

30. The construction chamber according to claim 1, wherein a detachable closure is provided on an underside or a lower section of the closed circumferential wall, which is connected to the closed circumferential wall in a media-tight manner.

31. A machine for producing three-dimensional component by selectively solidifying a construction material applied in layers by means of a jet acting on the construction material, comprising:
at least one process chamber which comprises at least one working surface aligned in an X/Y plane, to which a construction chamber is assigned, in which a substrate plate is movably controlled by a drive unit and on which the three-dimensional component is produced,
a jet source for generating the jet and at least one deflection device by which the jet is guided and deflected onto the construction material to be solidified in a construction cylinder,
an application and leveling device which is configured to be moved above the at least one working surface for applying the construction material relative to the construction chamber,
wherein the construction chamber is configured according to claim 1.
